(19) United States
(12) Patent Application Publication
(10) Pub. No.: US 2014/0279138 A1
(43) Pub. Date: Sep. 18, 2014

(54) SYSTEM AND METHOD FOR DETERMINING VALUATION OF ITEMS USING PRICE ELASTICITY INFORMATION

(71) Applicant: Auction.com, LLC., Irvine, CA (US)

(72) Inventor: Jake Seid, Irvine, CA (US)

(21) Appl. No.: 13/841,634

(22) Filed: Mar. 15, 2013

(51) Int. Cl. G06Q 30/02

(52) U.S. Cl. CPC G06Q 30/0278
USPC 705/26.3; 705/306

(57) ABSTRACT

A valuation of a subject item includes determining a transaction price for one or more comparable items. For each comparable transaction, one or more unsuccessful offers is determined. The valuation of the subject item may be based on a valuation of each of the one or more comparable items, and the valuation of each of the one or more comparable items may be based at least in part on the one or more unsuccessful offers for that item.

### TECHNICAL FIELD

Examples described herein relate to online markets, and more specifically, to a system and method for determining valuation of property using price elasticity information.

### BACKGROUND

Numerous online auction forums exist that enable consumers and sellers to transact for various kinds of items, such as collectibles, electronics and other goods or services.

### BRIEF DESCRIPTION OF THE DRAWINGS

FIG. 1 illustrates a computer system for determining valuation of items, according to an embodiment.

FIG. 2 illustrates a method for providing predictive valuation of an item based on a statistical determination of offers placed on comparable items, according to an embodiment.

FIG. 3 illustrates a method for using select offers to determine valuations, according to an embodiment.

FIG. 4 illustrates a method for determining valuation for an item based on elasticity determinations, according an embodiment.

FIG. 5 illustrates an example in which a valuation is determined and used in accordance with some embodiments.

FIG. 6 is a block diagram that illustrates a computer system upon which embodiments described herein may be implemented.

### DETAILED DESCRIPTION

Embodiments described herein include a system and method for determining valuation of items using price elasticity information. In many examples described herein, price elasticity information can be determined in part from unsuccessful offers received in the course of prior transactions for comparable items (or comparable transactions).

According to some embodiments, a system and method is provided for valuing items based in part on unsuccessful offers received in comparable transactions. In some examples, subject items can be valued based on results of comparable transactions which were completed through an auction process. The auction process of the past transactions can record a series of offers (or bids), including unsuccessful offers (or losing bids), as well as a transaction price (e.g., the winning bid). In examples described herein, valuation for a subject item can be obtained in part from the bid history recorded with comparable transactions conducted through an auction process.

Among other benefits, examples described herein recognize that appraisals and valuations can be skewed by outlier transactions and case-specific or random factors that generate price elasticity. By way of example, real-property transactions can sometimes result in a sale price that is not truly reflective of other similar properties that would be considered comparables. Under conventional valuation processes, the prior transactions influence the valuation determination, even when the prior transactions are outliers. In contrast, examples described herein recognize that for many kinds of items (e.g., real property), valuations can fluctuate because of various elasticity factors, such as randomness, or factors that are inherent and specific to a particular item. While conventional approaches generally do not account for such factors when basing valuation on comparable transactions, examples described here identify and utilize unsuccessful offers (e.g., losing bids in an auction) as a mechanism to determine valuation for an item in a manner that accounts for presence of elasticity factors.

By way of example, in real property, a property can be bid up above the normal range because of facets that are not considered in valuation processes, such as timing (e.g., seller puts home on market after stock market goes up), characteristics hidden from valuation (e.g., charm of house), general circumstance or luck (e.g., buyer is uneducated as to normal range of home in neighborhood). In contrast to conventional approaches, examples described herein utilize bidding history in determining valuation data for items in comparable transactions. Such valuation data can then be used to determine a valuation. Such valuations can be expressed in ranges or probabilities.

In one embodiment, a valuation of a subject item includes determining a transaction price for one or more comparable items. For each comparable transaction, one or more unsuccessful offers is identified. The valuation of the subject item may be based on a compilation of offers for the items of the comparable transaction, where the compilation of offers can include at least some of the unsuccessful offers the items of the comparable transactions received.

In another embodiment, a set of comparable transactions are determined for items that are comparable to a subject item receiving the valuation (e.g., comparable real property). For each comparable transaction, one or more unsuccessful offers are identified, and an alternative probable valuation is determined for the corresponding item of that transaction based at least in part on the one or more unsuccessful offers. The valuation for the particular item can be based at least in part on the determined alternative probable valuation of each comparable transaction.

In another embodiment, a candidate set of comparable transactions are identified. Each comparable transaction of the candidate set can be for a corresponding item that is deemed similar to the particular item. For each comparable transaction of the candidate set, an elasticity is determined in the transaction price of that comparable transaction, based at least in part on a comparison between the transaction price and one or more unsuccessful offers of the comparable transaction. The comparable transactions of the candidate set are identified in which the comparison between the transaction price and the unsuccessful bids exceeds an elasticity threshold. The valuation of the item is determined based at least in part on weighting down or eliminating the comparable transactions that exceed the elasticity threshold.

Still further, a set of comparable transactions can be identified for a subject item. A set of offers are determined for each comparable transaction of the identified set. For each comparable transaction of the identified set, a statistical distribution is determined from multiple offers of that transaction. A valuation of can be predicted for the subject item based on the statistical distribution. The valuation can be singular (e.g., most likely value) or a statistical distribution (e.g., multiple possible values with percentage likelihood).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Auction Architecture

FIG. 1 illustrates a computer system for determining valuation of items, according to an embodiment. A system 100 such as shown by an example of FIG. 1 can be implemented in connection with an online marketplace (or multiple online marketplaces) for which transactions between prospective buyers and sellers are conducted. In one example, system 100 is provided as a network service that augments or enhances an online marketplace for items of commerce. As another example, system 100 can be implemented as a service that utilizes information from an online marketplace to provide valuation for items of commerce independent of a specific transaction or marketplace. Examples of items of commerce include real property items, (e.g., homes, real-estate notes, commercial property), motor vehicles (e.g., automobiles, motorcycles, boats), and collectables. While an example of FIG. 1 illustrates implementation in context of an online auction forum, variations can be applicable to other kinds of online markets where the sale price of a given item is not fixed, but subject to multiple offers of different values.

In an example of FIG. 1, system 100 includes processes and functionality to implement a comparable determination 110, a valuation determination 120, a valuation interface 130, and a transaction database 140. The transaction database 140 can receive transaction information 142 from one or more transaction sources.

In one implementation, the transaction source can correspond to an online auction forum 150 that implements multiple auction processes for the transaction of items. In one implementation, the auction system 150 includes an offer interface 152, a transaction component 154, and a transaction log 156. The transaction component 154 can implement rules and logic for conducting an auction process for a particular item. The transaction component 154 can also display current state information 155 for individual transactions through the offer interface 152. The offer interface 152 can include search and navigation functionality for enabling prospective bidders to search/navigate for specific items. The offer interface 152 can also enable prospective bidders to submit new bids 153 that update the current state information 155 for a particular active transaction. In turn, the transaction component 154 updates the transaction log 156 so as to log the individual offer 151, including the winning offer or transaction price 161, as well as one or more unsuccessful (or losing) offers 163. In some variations the transaction log 156 can maintain other information such as timing information corresponding to, for example, time stamps when the individual offers were received, as well as descriptive information about the item of the transaction.

In an auction environment, the transaction information 142 can include identifiers 143 for items of commerce, descriptive information about the items (“descriptive information 145”), and transaction history 147. The transaction history 147 can include a transaction price (winning offer), and one or more unsuccessful (or losing) offers. The transaction history 147 can also include, for example, number of bidders or interested individuals for the item, as well as timing information as to when the offers occurred.

The valuation interface 130 can process a trigger 131 for determining a valuation 129 of a subject item 137. For example, a user can generate an input that identifies the subject item 137 (e.g., user enters a property address or parcel number or provides descriptive information about a collectible). In one implementation, the valuation interface 130 uses a comparable criteria process 132 to programmatically determine comparison criteria 139 for the subject item 137. Comparable criteria 139 can include one or more relevant categories for the item (e.g., whether home is single family or condominium, etc.; type of collectible, type of automobile), geographic information where the item is located or to be transacted (e.g., address or county for real-estate) and other material information (e.g., real-estate: number of bedrooms, number of baths, size of home, size of lot; automobile: mileage, options; collectibles: condition, ownership record).

The comparable determination 110 uses the comparison criteria 139 to generate a query 111 from the transaction database 140 for a set of comparable transaction records 113. The set of comparable transaction records 113 can identify items that satisfy the comparison criteria 139. For example, in the context of real property, the subject item 137 can correspond to a home in a particular geographic region, and the set of comparable transaction records 113 can identify comparable homes (e.g., same size, type, number of bedrooms and baths etc.) subject to a sale in a recent time period. Each of the comparable transaction records 113 can include transaction information 142 from the underlying transaction. For example, each record can identify a transaction 123, including the transaction price 125, and one or more unsuccessful (or losing) offers 127. In a variation, the transaction information 142 can also include the number of bidders or prospective buyers for the item and/or timing information for when the offers were received.

The valuation determination 120 uses comparable transactions 123, including the transaction price 125 and unsuccessful offers 127 in determining a valuation 129 for the subject item 137. The determination of valuation 129 can include elasticity logic 122, which factors in pricing elasticity. In particular, the elasticity logic 122 can implement rules for factoring in elasticity factors, such as statistical distributions. The valuation 129 can include, for example, any one or more of (i) a range of likely values, (ii) a single most-likely value, and/or (iii) multiple values mapped to indication of a statistical probability. In determining the valuation 129, the elasticity logic 122 can factor in the unsuccessful offers 127 to discount or replace the transaction price 125 of the comparable transaction for purpose of determining the valuation 129 for the subject item 137.

Methodology

FIG. 2 illustrates a method for providing predictive valuation of an item based on a statistical determination of offers placed on comparable items, according to an embodiment. FIG. 3 illustrates a method for using select offers to determine valuations, according to an embodiment. FIG. 4 illustrates a method for determining valuation for an item based on elasticity determinations, according an embodiment. In describing example methods such as described with FIG. 2 and FIG. 3, reference may be made to elements of FIG. 1 for purpose of illustrating suitable components for performing a step or sub-step being described.

With reference to an example of FIG. 2, a valuation determination is initiated for a particular item (210). The valuation determination can be triggered automatically in response to a predetermined event (e.g. a user submits an item for sale on an auction site), or in response to manual event (e.g., the user operates an online service to request the valuation for a particular item). Depending on implementation, the item can correspond to, for example, real property, a motor vehicle or automobile, a collectible, or other item for which valuation can be determined primarily prior transaction prices, rather than from retail pricing or manufacturers.

A set of comparable transactions is determined for the item that is receiving the valuation (220). The comparable transactions can be determined either programmatically or manually. In particular, the comparable transactions can be determined by identifying other items that are comparable to the subject item that is receiving the valuation. Generally, the determination of comparables is based on matching material characteristics of the subject item to other items that were recently transacted. In determining comparables, one implementation provides for parsing text and other content that is descriptive of the subject item in order to determine material characteristics of that item. The comparables to the subject item can share characteristics as to geographic location, general type, size and other facets. For example, in real property, comparable properties can be in a similar location or neighborhood, and of the same or similar property type, bedroom number, lot size and/or square footage. In automobiles, the comparables can include geographic region, vehicle and model, year of manufacture, type and condition. For collectibles, comparables can be identified based on, for example, condition, source, vintage, and other characteristics.

Once the material characteristics are determined, comparable items that have been subjected to transactions with similar or matching characteristics (or which satisfy a threshold of similarity as between material characteristics) are identified. In an online auction environment, the transaction log 156 can be analyzed to identify transactions that are suitable points of comparisons as compared to the subject item that is receiving the valuation. For example, information about the subject item 137 can be submitted through the valuation interface 130 through pictures and descriptive text provided by the user.

According to some embodiments, prior offers for comparable items are aggregated (230). The prior offers can include both successful offers (i.e., transaction price) and unsuccessful offers. In some variations, the unsuccessful offers are aggregated only if they satisfy a defined threshold. In one implementation, the defined threshold can be satisfied if an unsuccessful offer is one of a designated number (n) of highest offers that are recorded with each transaction (232). For example, the three highest offers for each comparable transaction can be determined and aggregated. In another implementation, all offers within a designated range are identified and aggregated. For example, those unsuccessful offers that are within X % of the transaction price can be aggregated (234). Still further, in an auction environment, all offers above a reserve can be aggregated (236).

The valuation of the subject item can be determined based on the various offers that are aggregated from the comparable transactions (240). In one implementation, those offers that satisfy a predefined threshold are used in determining the valuation of the subject item. In one implementation, the calculated average can be determined from a sum, average or weighted average of the various values included with the aggregated offers (242). For example, a weighted average may be determined for one or more of the prior transactions, where the transactional price is weighted more than the unsuccessful bids. In a variation, the valuation of the subject item can be determined from statistical analysis of the aggregate offers (244). For example, those offers for comparable transactions which satisfy some threshold condition can be aggregated into a statistical cluster that identifies a likelihood for the ultimate transaction price of the subject item. In one implementation, the predictive valuation can identify a single price that is statistically determined to be the most likely valuation for the subject item receiving the valuation. The statistical determination can also be expressed as a range. Still further, standard mean deviation can provide information that is indicative of the likelihood that the valuation of the item will exceed the most likely value.

By way of example, given the case where the item receiving the valuation is a home, and where there are comparable transactions showing the following offer activity: (1) Transaction price ($1,000,000), next highest unsuccessful offers: $950,000, $940,000, $900,000; (2) Transaction price ($950,000), next highest unsuccessful offers: $945,000, $940,000; and (3) Transaction price ($945,000), next highest unsuccessful offers: $940,000, $938,000. In this example, statistical clustering can identify a predictive value of $950,000 for the item receiving the valuation. As an alternative or variation, the statistical clustering can also be used to identify a range. For example, the likely range in which the item being sold can be priced may be determined from statistical clustering of the winning and unsuccessful offers of the identified comparable transactions. In the example provided, the range can be identified from an average of successful and unsuccessful bids. As a variation, the range can be identified from the successful bids and a designated number of unsuccessful bids that satisfy some criteria or threshold. By way of example, unsuccessful bids may satisfy threshold by being within x % (e.g., 10%) of the transaction price, or one of n (e.g., 3 highest losing bids) unsuccessful offers that are greatest in amount.

With reference to FIG. 3, comparable transactions can be determined for a subject item that is receiving the valuation (310). For each comparable transaction, a set of select offers are determined (320). The select offers can include the winning/transaction price (322) and one or more unsuccessful/losing offers (324). The unsuccessful offers can be selected based on those offers satisfying some designated threshold or criterion. For example, the select unsuccessful offers can satisfy the condition of being one of the n highest offers, or with in X % of the ultimate transaction price.

The select offers are then used to determine valuation for the item (330). As described with other examples, different formulas or rules can be used to determine the valuation based on the select offers (which include both winning and unsuccessful offers). Furthermore, valuation can be determined as discrete values, range of values, or as a set of probabilistic values (e.g., likelihood an item will receive a given value when transacted). In one implementation, an elasticity parameter is determined using the unsuccessful offers for the individual comparable transactions (332). The elasticity parameter can correspond to a range, scalar or numeric factor, from which a variation can be determined. In a variation, the valuation of the subject item can be based on transaction prices and elasticity (334). The value of the elasticity parameter can be used to discount the value of the comparable transaction, so that those comparable transactions with outlier winning offers are significantly devalued prior to being incorporated as part of the valuation for the subject item. As an alternative or variation, the value of the elasticity parameter can be aggregated and applied against the overall valuation as determined from, for example, the transaction price of each comparable transaction.

By way of example, elasticity may indicate a scalar variation of 10%. For example, one implementation, the elasticity scalar can reduce the valuation that is based on the transaction price for each comparable transaction.

In a variation, the valuation can be determined from select offers by comparing, for each comparable transaction, the transaction price to one or more of the unsuccessful offers (336). This determination can seek to exclude or discount the transaction price for the comparable transaction for purpose of determining valuation if the transaction price exceeds some threshold (338). Thus, for example, if in a blind auction, the winning offer significantly exceeds the unsuccessful offer, for purpose determining valuation, the winning offer may be excluded or discounted.

With reference to an example of FIG. 4, valuation of a subject item (e.g., real property, automobile, collectible) is initiated by identifying a set of candidate transactions (410). In particular, the transactions are for comparable items which satisfy a criteria (412). For each candidate transaction, a set of offers is identified (420). The offers for each candidate transaction can include a transaction offer (or winning offer) and one or unsuccessful offers. For example, the unsuccessful offers that are considered can include (i) all unsuccessful offers, (ii) those unsuccessful offers that are above a threshold amount, (iii) those unsuccessful offers which are within some designated threshold of the transaction price, and/or (iv) those offers which were the X best, where X is greater than 2. The transaction price can be compared to the unsuccessful offers to determine an elasticity parameter for each transaction (422).

Those transactions which exceed a specific elasticity can be excluded from the set of transactions (430). In particular, an example of FIG. 4 recognizes that some comparable transactions can include outlier winning offers that are not accurate predictors of the valuation for the subject items. If any transaction includes an elasticity parameter (or difference between winning and unsuccessful offer) that exceeds some threshold, then that transaction can be flagged. In the example of FIG. 4, a transaction with the outlier winning offer can be excluded from the set of comparable transactions. In variations, the comparable transaction with the outlier winning offer can be modified for purpose of determining the valuation using that particular transaction. For example, the comparable transaction can be discounted to reflect a hypothetical valuation that excludes the winning transaction (e.g., is based on the highest unsuccessful offer, or on an average of the highest unsuccessful offers), or discounts the winning transaction by some parameter that is based on the elasticity determination of that transaction.

In some embodiments, the valuation of the subject item can then be determined based on the remainder of the comparable transactions (440). More specifically, in one implementation, those transactions that include elasticity parameters exceeding a specific threshold can be identified and excluded for the purpose of determining valuation of the subject item.

### Example

FIG. 5 illustrates an example in which a valuation is determined and used in accordance with some embodiments. The transaction record 500 can correspond to, for example, an item that is auctioned, or alternatively to an item that is listed for sale in an online forum. In an example of FIG. 5, a transaction record 500 identifies a subject property, which can include descriptive information and images. The descriptive information can include comparison parameters 510, such as number of bedrooms, number of bathrooms, year built, square footage, lot size etc. Other comparison parameters can include geographic region, property type, and state of title (e.g., short sale). The comparable parameters can be used to determine comparable transactions, or candidates thereof, for the purpose of determining a valuation for the subject property.

In one implementation, the comparison parameters 510 can be determined based at least in part on programmatic processes. For example, in one implementation, a user (e.g., seller) can enter information that identifies the subject property by address and/or parcel. In response to the entered information, programmatic processes can query or otherwise access online sources to determine some or all of the comparable information. For example, programmatic processes can access county tax records, mapping services, MLS (or Multiple Listing Service) listings and other sources in order to determine information about the subject property. As a variation, the user can be prompted to manually provide some or all of the information needed for the comparison parameters 510.

Valuation information 520 can be determined in a variety of ways. A conventional valuation 522 can, for example, be determined from comparable transactions without consideration of elasticity factors. Additionally, one or more valuations 524 can be determined and displayed that consider elasticity. For example, the valuation 524 can be determined based on examples such as described in preceding examples.

As another variation, an elasticity parameter 526 can be displayed which shows the potential variation of the valuation 522 based on elasticity measurements in prior transactions.

As another variation, one or more predictive valuations 528 can be displayed which show most likely transaction prices for the subject property based on a stochastic analysis of prior offers (both winning and unsuccessful) for comparable properties. Still further, the predictive valuations can display a possible valuation 529 and an estimated chance of obtaining the valuation based on prior offers for comparable properties. For example, the highest valuation can be displayed with a percentage or other indicator for that valuation to be realized, in addition to a most likely valuation and the lowest valuation with corresponding percentages for those valuations to be realized for the subject item.

As still another variation, the valuation 522 can be displayed with a graphic or qualitative indicator that indicates the strength of the valuation given the determined elasticity in the comparable transactions. For example, color coding or ranking can be used to indicate the strength of the valuation 522, with stronger valuations having less elasticity present in the comparable transactions.

In other examples, bidders of an auction can obtain valuations for items of interest in order to determine bidding strategy. For example, bidders may be able to determine which item to bid on based on the valuation of each item of interest.

Alternatives and Variations

While many examples described herein provide for determining valuation based on offers received in comparable transactions, other determine elasticity from other factors. Among them, the market trends are activity can be used to influence the valuation a subject item receives. For example, if items of a particular category receive a lot of bids and bidding activity, the elasticity determination may factor in a robust bidding environment. Likewise, if items of a particular activity receive few bids, then other considerations can be made, such as discounting outlier transactions even further. Other facets, such as general market trends can also influence elasticity determination and subject item valuation.

While many examples provide for online auction forums, other examples can be implemented in other market forums, including those forums where haggling can occur. Additionally, data from offline auctions can be used as an alternative to online auction forums.

Computer System

FIG. 6 is a block diagram that illustrates a computer system upon which embodiments described herein may be implemented. For example, in the context of FIG. 1, system 100 may be implemented using one or more servers such as described by FIG. 6.

In an embodiment, computer system 600 includes processor 604, memory 606 (including non-transitory memory), storage device 610, and communication interface 618. Computer system 600 includes at least one processor 604 for processing information. Computer system 600 also includes the main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. The storage device 610, such as a magnetic disk or optical disk, is provided for storing information and instructions. The communication interface 618 may enable the computer system 600 to communicate with one or more networks through use of the network link 620 (wireless or wireline). The communication interface 618 may communicate with bidders and auction participants using, for example, the Internet.

Embodiments described herein are related to the use of computer system 600 for implementing the techniques described herein. According to one embodiment, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for determining a valuation of a subject item, the method being implemented by one or more processors and comprising:
determining multiple comparable transactions;
identifying a set of offers for each of the comparable transactions, the set of offers for each comparable transaction including multiple offers, including one or more unsuccessful offers;
calculating the valuation for the subject item based on each offer from the set of offers of at least some of the comparable transactions.

2. The method of claim 1, wherein calculating the valuation includes determining a statistical distribution of offers from the set of offers for at least some of the comparable transactions.

3. The method of claim 1, wherein identifying the set of offers includes excluding, from a given one of the set of offers, one or more transactions that do not meet a defined threshold.

4. The method of claim 3, wherein identifying the set of offers includes identifying the n highest offers from the set of offers for each of the multiple transactions, wherein n is greater than 1.

5. The method of claim 3, wherein identifying the set of offers includes identifying those offers from the set of offers for each of the multiple transactions which are within a given range of a transaction price for a corresponding one of the multiple transactions.

6. The method of claim 1, wherein determining the valuation includes determining one or more possible valuations, and a probability that each of the one or more possible valuations will be realized for the subject item based on the statistical distribution.

7. The method of claim 1, wherein the subject item is a real property, and wherein determining the set of comparable transactions includes determining a set of comparable transactions for real property.

8. The method of claim 1, wherein the subject item is one of a real property, a collectible, or an automobile.

9. The method of claim 1, wherein determining the set of comparable transactions includes programmatically determining a set of comparison parameters for the subject item based at least in part on an input of the user, then programmatically using the set of comparison parameters to determine the set of comparable transactions.

10. A method for determining a valuation of a subject item, the method being implemented by one or more processors and comprising:
determining a set of comparable transactions, wherein each comparable transaction of the set is for a corresponding item that is deemed similar to the subject item;
for each the comparable transaction of the set, (i) identifying one or more unsuccessful offers, and (ii) determining a alternative probable valuation for the corresponding item of that transaction based at least in part on the one or more unsuccessful offers; and
determining the valuation of the subject item based at least in part on the alternative probable valuation of each comparable transaction in the set.

11. The method of claim 10, wherein determining the alternative probable valuation for each comparable transaction in the set includes basing the alternative probable valuation on a next highest offer, and not on a winning offer, for that comparable transaction.

12. The method of claim 10, wherein determining the alternative probable valuation for each comparable transaction in the set includes basing the alternative probable valuation on one or more unsuccessful offers for that comparable transaction.

13. The method of claim 10, further comprising averaging or weighting the one or more unsuccessful offers in determining the alternative probable valuation.

14. The method of claim 10, wherein determining the alternative probable valuation for each comparable transaction in the set includes determining an elasticity range for each of the one or more comparable transactions based at least in part on a difference between the winning offer and one or more unsuccessful offers for that comparable transaction.

15. The method of claim 10, further comprising determining the alternative probable valuation of the corresponding item for each comparable transaction of the set without disclosing any of the one or more unsuccessful offers and/or the alternative probable valuation for that comparable transaction.

16. The method of claim 10, further comprising hosting an online auction forum, from which the set of comparable transactions are identified from historical data, and wherein determining the valuation for the subject item is determined without disclosing any of the one or more unsuccessful offers for a corresponding property of the comparable transactions.

17. The method of claim 10, wherein the subject item is a real property, and wherein determining the set of comparable transactions includes determining a set of comparable transactions for real property.

18. The method of claim 10, wherein the subject item is one of a real property, a collectible, or an automobile.

19. The method of claim 10, wherein determining the set of comparable transactions includes programmatically determining a set of comparison parameters for the subject item based at least in part on an input of the user, then programmatically using the set of comparison parameters to determine the set of comparable transactions.

20. A method for determining a valuation of a subject item, the method being implemented by one or more processors and comprising:
determining a candidate set of comparable transactions, wherein each comparable transaction of the candidate set is for a corresponding item that is deemed similar to the particular item;
for each the comparable transaction of the candidate set, determining an elasticity in the transaction price of that comparable transaction based at least in part on a difference between the transaction price and one or more unsuccessful offers; and
determining each comparable transactions of the candidate set that has the determined elasticity of the transaction price exceed a threshold; and
determining the valuation of the subject item based at least in part by weighting down or eliminating the comparable transactions of the candidate set which have the elasticity of the transaction price exceeding a designated threshold.

21. The method of claim 20, further comprising determining the valuation of the subject item based at least in part on the transaction price of any comparable transactions of the candidate set which have the elasticity of the transaction price being is less than the designated threshold, while weighting against or eliminating, from the candidate set, the transaction price of the comparable transactions of the candidate set which have the elasticity of the transaction price that is greater than the designated threshold.

22. A method for determining a valuation of a subject item, the method being implemented by one or more processors and comprising:
identifying a transaction price for one or more comparable items of the subject item;
identifying one or more unsuccessful offers for each of the one or more comparable items;
determining the valuation of the subject item based at least in part on the one or more unsuccessful offers for each of the one or more comparable items.

23. The method of claim 22, wherein determining the valuation of the subject item includes determining an elasticity parameter for one or more of the comparable items based at least in part on one or more unsuccessful offers for each of the one or more comparable items.

24. The method of claim 23, wherein determining the valuation of the subject item includes basing the valuation of each of the one or more unsuccessful offers based on a reduction in the transaction price for that comparable item, the reduction being based at least in part on the elasticity parameter.

25. The method of claim 22, further comprising visually indicating the elasticity parameter of the transaction price when displaying the valuation of the subject item.

26. The method of claim 22, further comprising determining the valuation of the subject item based at least in part on the transaction price and the elasticity parameter.
